(19) United States
(12) Patent Application Publication
(10) Pub. No.: US 2008/0243692 A1
(43) Pub. Date: Oct. 2, 2008

(54) CONTENT INGEST, MAINTENANCE, AND DELIVERY

(75) Inventors: John K. Trimper, Groton, MA (US); Stephen D. Morrrison, Watertown, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignees: Verizon Services Corp., Arlington, VA (US); Verizon Select Services Corp., Irving, TX (US)

(21) Appl. No.: 11/694,167

(22) Filed: Mar. 30, 2007

(51) Int. Cl. H04L 9/00

(52) U.S. Cl. 705/51

(57) ABSTRACT

A method may include receiving content in a server from a remote device; receiving a request to manufacture an optical medium including the content by a manufacture remote from the device; burning the optical medium including the content by the manufacturer; and receiving an identity of an intended recipient of the medium for delivering the optical medium. A method may include receiving first content in a first format and storing the first content in a server; receiving a request for the first content from a first user device; determining format information associated with the first user device; transcoding the first content for the first user device, wherein transcoding includes changing the first format of the first content based on the format information associated with the first user device; and transmitting the transcoded first content to the first user device.

### BACKGROUND INFORMATION

There are many different types of content: music, home video, movies, pictures, etc. There are also many different ways of experiencing content. Content may be watched on a television, a mobile phone, a personal digital assistant, or a computer. Content may be listened to on a radio, a computer, a stereo, or a portable music player. Further, there are also many different sources of digital content. Content may be created at home with a video camera, in a Hollywood movie studio, or in a recording studio by a record company, for example.

### BRIEF DESCRIPTION OF THE DRAWINGS

FIG. 1 is an exemplary block diagram of an environment for managing digital content;

FIG. 2 is a block diagram of exemplary components of a customer computer;

FIG. 3 is a block diagram of exemplary components of content servers;

FIG. 4 illustrates an exemplary functional diagram of content servers in one embodiment; and

FIGS. 5, 6, and 7 are flowcharts of exemplary processes for maintaining content in exemplary embodiments.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

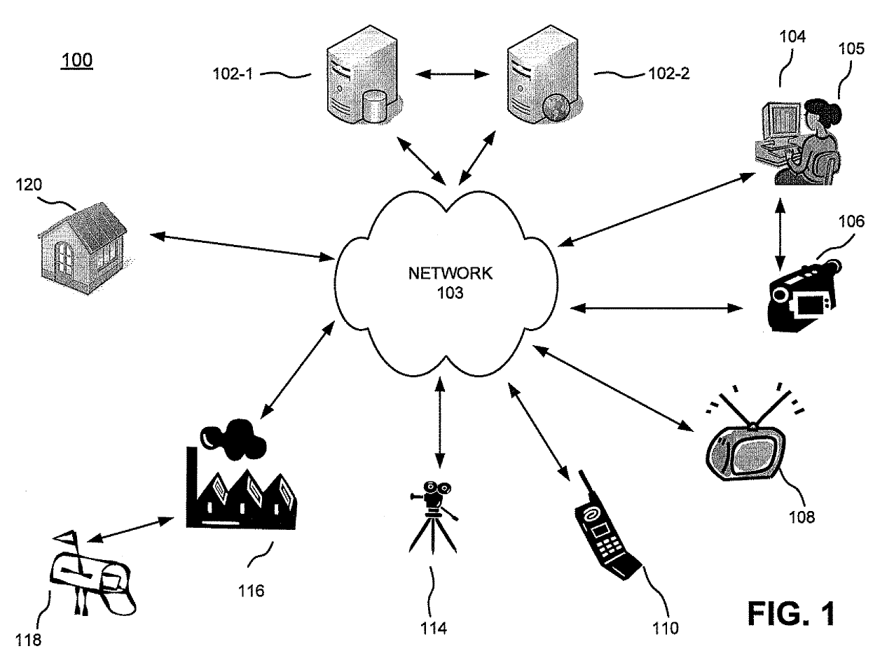

FIG. 1 is an exemplary block diagram of an environment 100 for managing digital content. As shown in FIG. 1, digital content may originate from a variety of different sources. Content may also be delivered to various different destinations, as shown in FIG. 1. As the term is used herein, “content” may include any type of digital content, including audio, video, pictures, graphics, games, web pages, television programming, etc.

Environment 100 may include a network 103, customer computer 104, a video camera 106, a television 108, a mobile phone, 110, a Hollywood studio 114, a manufacturing on demand facility (“MoD facility 116”), a post office 118, a public building 120, a content server 102-1, and a web server 102-2 (collectively “servers 102” or “content system 102,” individually “server 102-x”). The devices shown in FIG. 1 may be in communication with each other through network 103. Some devices, such as customer computer 104 and video camera 106 may be in communication directly with each other rather than through network 103. In practice, there may be more, different, or fewer devices or a different arrangement of devices than what is shown in FIG. 1.

Servers 102 may be located in a service provider's network (e.g., a telephone company's network, an Internet service provider's network, etc.). Servers 102 may provide services to customers, such as a video-on-demand (VoD) service, through network 103. Content server 102-1 may store content for delivering to devices, such as customer computer 104, through network 103, for example. Web server 102-2 may allow customer 105 to log into his account and configure settings for services to which customer 105 has subscribed. Web server 102-2 may also allow for the uploading content for storage in content server 102-1. Web server 102-2 may also facilitate the access, retrieval, and deliver of content from content server 102-1 through network 103.

Network 103 may include one or more networks or sub-networks of any type, including a local area network (LAN), a wide area network (WAN), a satellite network, a metropolitan area network (MAN), a telephone network, such as the Public Switched Telephone Network (PSTN) or a Public Land Mobile Network (PLMN), an intranet, the Internet, or a combination of networks. The PLMN(s) may further include a packet-switched sub-network, such as, for example, General Packet Radio Service (GPRS), Cellular Digital Packet Data (CDPD), or Mobile IP sub-network.

Customer computer 104, video camera 106, and television 108 may be located in a telephone company's customer's house, for example. Customer computer 104 may be a personal computer, personal digital assistant (PDA), cell phone, or laptop. In one embodiment, customer computer 104 and mobile phone 110 may be integrated into one device. Customer computer 104 may allow for downloading content through network 103 from servers 102 for viewing or listening. Customer computer 104 may also allow customer 105 to upload content to content server 102-1. Video camera 106 may allow for the recording of video. Video camera 106 may also allow recorded video to be transferred to customer computer 104 or to be uploaded through network 103 to content storage server 102-1, for example.

Television 108 may include a monitor, a set-top box (“STB,” not shown), and a remote control (not shown). Television 108 may allow for a viewing of content, such as content from content delivered through network 103 from content server 102-1. Television 108 may also allow for viewing of content from broadcast television.

Mobile phone 110 may allow for placing or receive telephone calls via network 103. Mobile phone 110 may download content through network 103 from content system 102. Mobile phone 110 may also allow for playing of content, such as content received through network 103 from content server 102-1. Mobile phone 110 may include a microphone and video camera and may allow for the creation of content. Mobile phone 110 may allow for the upload of content through network 103 to content server 102-1, for example.

Hollywood studio 114 may allow for the recording of professional-grade content, such as movies and music. Hollywood studio 114 may allow for the sending of content through network 103 for storage in content server 102-1, for example.

MoD facility 116 may allow for the manufacture of digital storage media, such as optical media or other physical media (e.g., a flash drive, magnetic disk, etc.). Optical media may include digital versatile disks (DVD), High-Definition (“HD”) DVDs, and Blue-ray optical disks. MoD facility 116 may receive content for storing on a manufactured media through network 103 from content server 102-1, for example. MoD facility 116 may manufacture a DVD by “replicating,” e.g., “pressing,” a DVD. MoD facility 116 may also manufacture a DVD by “burning” a DVD, e.g., using a laser to manufacture the DVD. After manufacture of a DVD, MoD facility may effect the delivery of the DVD via a postal or courier service, such as post office 118. Post office 118 may deliver physical media to a post office (not shown) near customer 105, for example, for pickup. MoD facility may create a custom label for a manufactured DVD or DVD case. MoD facility 116 may also provide customization by adding content to the physical media, such as content including the same information as in the custom label.

Public building 120 may include a high school, a government agency, or other municipal building, for example. In the embodiment of a high school, public building 120 may host and record school plays or classroom lessons. In the embodiment of a government agency, public building 120 may host and record public meetings. Public building 120 may allow for the delivery of content through network 103 to content server 102-1, for example.

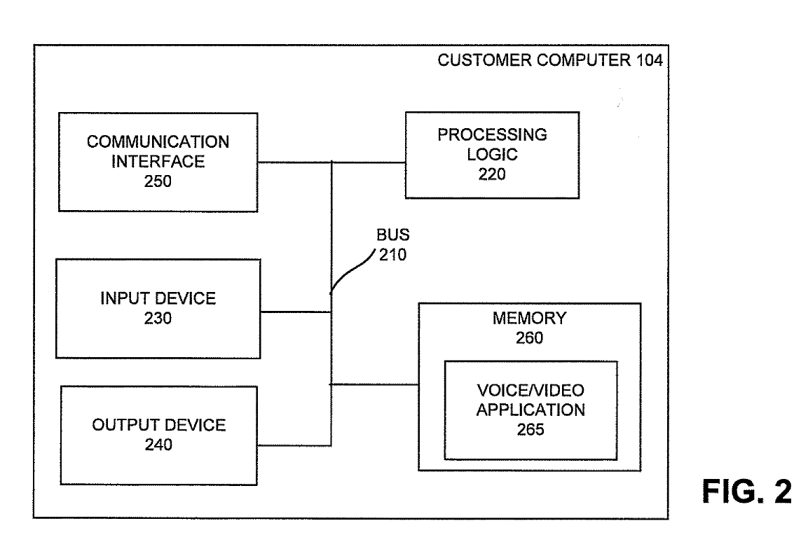

FIG. 2 is a block diagram of exemplary components of customer computer 104. Customer computer 104 may include bus 210, processing logic 220, input device 230, output device 240, communication interface 250, and memory 260. Customer computer 104 may include other components (not shown) that aid in receiving, transmitting, and/or processing data. Moreover, other configurations of components in customer computer 104 are possible. Further, one or more components of customer computer 104 may be remotely located.

Bus 210 may include a path that permits communication among the components of customer computer 104. Processing logic 220 may include any type of processor or microprocessor (or groups of processors or microprocessors) that interprets and executes instructions. In other embodiments, processing logic 220 may include an application-specific integrated circuit (“ASIC”), a field-programmable gate array (“FPGA”), or the like. Processing logic 220 may also include hybrid circuitry that performs both analog and digital functions.

Communication interface 250 may include any transceiver-like mechanism that enables customer computer 104 to communicate with other devices and/or systems. Memory 260 may include a random access memory (“RAM”) or another type of dynamic storage device that may store information and instructions for execution by processing logic 220; a read-only memory (“ROM”) device or another type of static storage device that may store static information and instructions for use by processing logic 220; and/or some other type of magnetic or optical recording medium and its corresponding drive for storing information and/or instructions. Memory 260 may store a voice/video recording application 265, for example. Voice/video-recording application 265 may allow customer computer 104 to record content for customer 105 to upload to web server 102-2 (for storage in content server 102-1). Applications other than a voice/video recording application 265 are possible, such as a web browser for interacting with web server 102-2.

Input device 230 may include a device that permits a user to input information into customer computer 104, such as a keyboard, a keypad, a mouse, a pen, a microphone, a video camera, one or more biometric mechanisms, or the like. Output device 240 may include a device that outputs information to the user, such as a display, a printer, a speaker, etc.

Customer computer 104 may perform certain operations, as described in detail below. Customer computer 104 may perform these operations in response to processing logic 220 executing software instructions contained in a computer-readable medium, such as memory 260. A computer-readable medium may be defined as a physical or logical memory device and/or carrier wave. The software instructions may be read into memory 260 from another computer-readable medium or from another device via communication interface 250. The software instructions contained in memory 260 may cause processing logic 220 to perform processes that are described below.

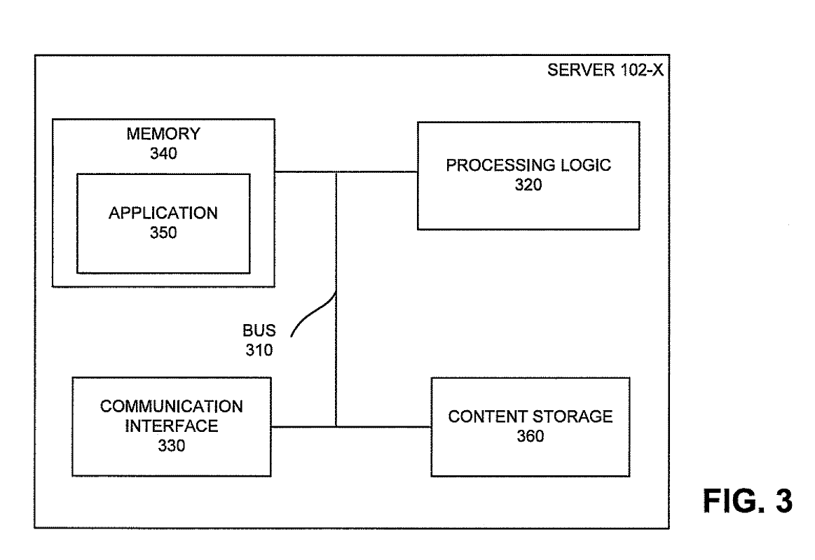

FIG. 3 is a block diagram of exemplary components of server 102-x. Server 102-x may include bus 310, processing logic 320, communication interface 330, and memory 340, and content storage 360. Server 102-x may include other components (not shown) that aid in receiving, transmitting, and/or processing data. Moreover, other configurations of components in server 102-x are possible. For example, one or more components of server 102-x may be remotely located.

Bus 310 may include a path that permits communication among the components of server 102-x. Processing logic 320 may include any type of processor or microprocessor (or groups of processors or microprocessors) that interprets and executes instructions. In other embodiments, processing logic 320 may include an ASIC, FPGA, or the like.

Communication interface 330 may include any transceiver-like mechanism that enables server 102-x to communicate with other devices and/or systems. Memory 340 may include a RAM or another type of dynamic storage device that may store information and instructions for execution by processing logic 320; a ROM or another type of static storage device that may store static information and instructions for use by processing logic 320; and/or some other type of magnetic or optical recording medium and its corresponding drive for storing information and/or instructions. Memory 340 may store, for example, an application 350. Application 350 may allow each of servers 102-x to perform functions assigned to it. For example, application 350 in web server 102-2 may include a web server application, such as Apache. Application 350 in content server 102-1 may include a database application, such as MySQL. Application 350 in content server 102-1 may also include codecs for transcoding content from one format to another. Applications other than those listed above are possible.

Server 102-x may be a virtual server, that is, server 102-x may include a group of servers that may logically appear as one server. Content storage 360 may include magnetic or optical recording medium and its corresponding drive for storing content. Content storage 360 may include networked attached storage (“NAS”). Content storage 360 may also include a group of storage devices, such as a group of disks, that are geographically diverse. Content storage 360 may store content redundantly distributed over a group of storage devices for backup purposes or to provide content geographically close to customers.

Server 102-x may perform certain operations, as described in detail below. Server 102-x may perform these operations in response to processing logic 320 executing software instructions contained in a computer-readable medium, such as memory 340. The software instructions may be read into memory 340 from another computer-readable medium or from another device via communication interface 330. The software instructions contained in memory 340 may cause processing logic 320 to perform processes that are described below.

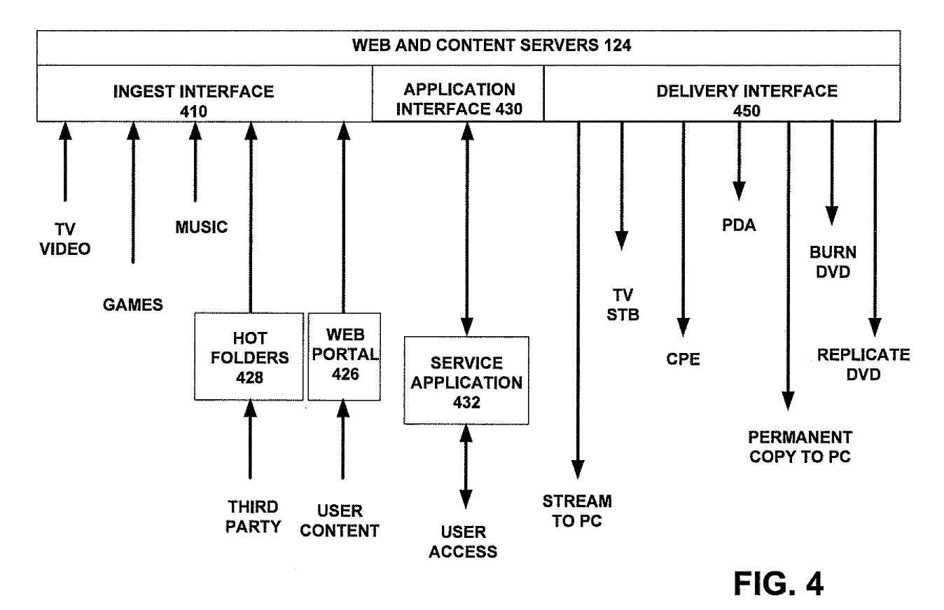

FIG. 4 illustrates an exemplary functional diagram of servers 102. As illustrated, servers 102 may include an ingest interface 410, an application interface 430, and a delivery interface 450. Ingest interface 410 may receive a variety of content from a variety of sources and may reformat, e.g., transcode, the content. The content may include content from television networks (such as Hollywood studio 114). The content may also include games from software companies. The content may include music from music studios, for example.

In one implementation, content may be received from users via a web portal 426 provided by web server 102-2. Web-portal 426 may allow customer 105 to manually enter information regarding the content for forwarding to ingest interface 410. For example, as described in more detail below, a user may associate content with sharing information (e.g., indicating private or public sharing). Content may also be received through “hot folders” 428, e.g., a file-transfer protocol (“FTP”) system. For example, a large-volume content provider may have a web-account with content system 102 and may copy content into hot folders 428.

Application interface 430 may allow users to interact with content associated with servers 102. For example, service application 432 may allow a user to view a list of content associated with servers 102 through application interface 430. In addition, application interface 430 may allow a user access and modify the content. Application interface 430 may be provided using web server 102-2.

Delivery interface 450 may allow servers 102 to deliver content to devices. For example, delivery interface 450 may allow content to be streamed to a PC (such as computer 104). Delivery interface 450 may provide content to a TV video on demand (VoD) server or set-top box (such as television 108) or managed customer premises equipment (“CPE”), e.g., a TV-Mate. Delivery interface 450 may provide content to a portable digital assistant (such as mobile telephone 110). Delivery interface 450 may provide content to a personal computer (such as customer computer 104) for permanent storage. Delivery interface 450 may also provide the content to a manufacturer (such as MoD facility 116) for content to be burned to a DVD and mailed to a user. Delivery interface 450 may also provide content for DVD replication.

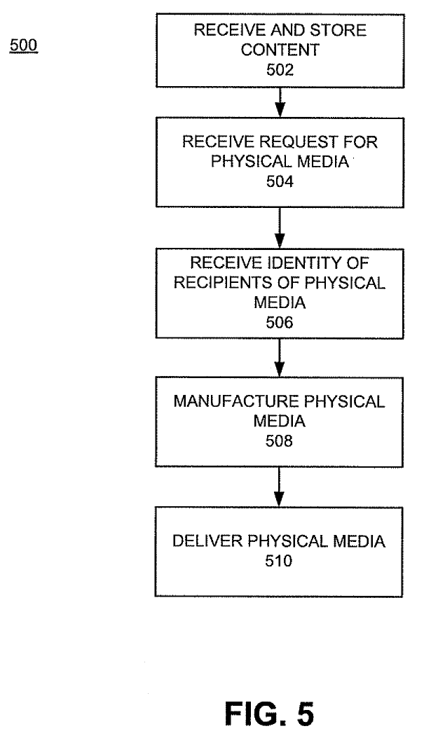

FIG. 5 is a flowchart of an exemplary process 500 for maintaining content in one exemplary embodiment. Process 500 may begin with content system 102 receiving and storing content (block 502). For example, customer 105 may upload content through web portal 426 provided by web server 102-2, e.g., through ingest interface 410. Web server 102-2 may store uploaded content on content server 102-1. As indicated above, content may be received by servers 102 through a variety of sources. Content generated by customer 105 may be considered user generated content (“UGC”). Content may also be provided by other sources, such as Hollywood studio 114.

Servers 102 may receive a request for the manufacture of physical media (block 504). For example, customer 105 (using customer computer 104) may request the manufacture of a DVD including content stored on content server 102-1. Servers 102 may receive the identity of recipients of the physical media (block 506). For example, customer 105 may use web portal 426 provided by web server 102-2 to identify the postal address of one or more recipients of the physical media.

Physical media may be manufactured (block 508). For example, servers 102 may send the content requested to be included in the manufactured physical media to MoD facility 116. MoD facility 116 may manufacture the physical media, e.g., a DVD. MoD facility 116 may burn a DVD including the content. Alternatively, MoD facility 116 may replicate a DVD including the content. The manufactured physical media may be delivered (block 510). For example, after manufacture of the physical media including the content, MoD facility 116 may deliver or cause the delivery (through the mail or courier service) of the physical media to the identified recipient(s).

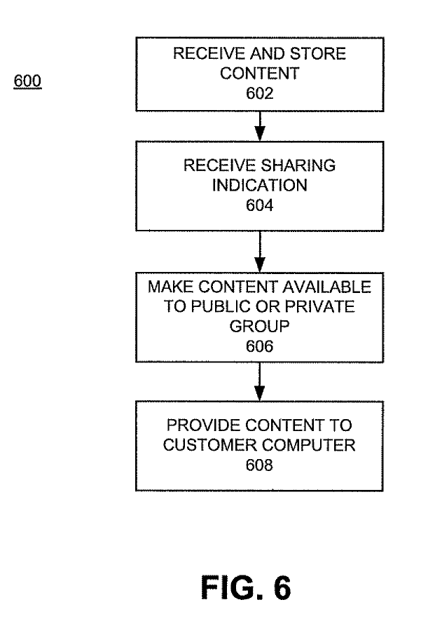

FIG. 6 is a flowchart of an exemplary process 600 for maintaining content in one exemplary embodiment. Process 600 may begin with servers 102 receiving and storing content (block 602). As indicated above, the content may be received from a variety of sources. The content may be associated with a sharing indication (block 604). For example, a user may indicate content as public (available to everyone) or private (available to a defined list of users). The content may be made available to the indicated group (public or private) (block 606). For example, content system 102 may make the content available to the indicated group. Content system 102 may provide the content to a user in response to a request (block 608). For example, the content may be delivered to customer 105 by delivering the content to customer computer 104. The content may also be provided to any of devices in FIG. 1, for example. The content may be delivered for permanent storage. In another embodiment, the content with digital-rights management (“DRM”) protection may be delivered for permanent storage.

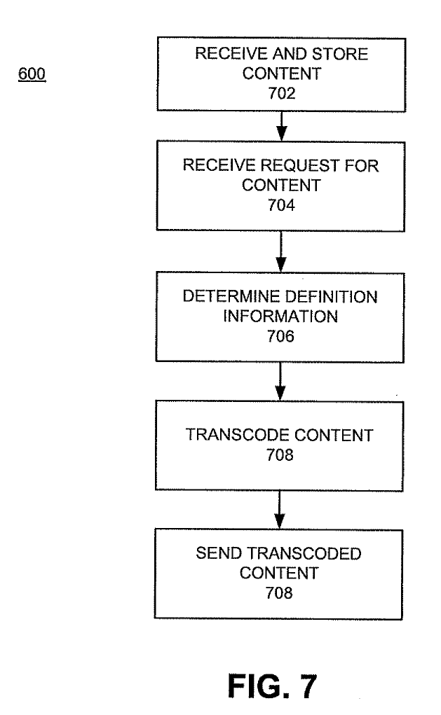

FIG. 7 is a flowchart of an exemplary process 700 for maintaining content in one exemplary embodiment. Process 700 may begin with servers 102 receiving and storing content (block 702). Servers 102 may receive a request for the content (block 704) to be provided on a device. For example, the device may be television 108, mobile phone 110, or customer computer 104. Each of these devices may support a different format associated with displaying or playing content. As used herein, “format” may include the supported bit-rate, resolution, compression type, and/or frame rate. For example, television 108 may be a high-definition, wide-screen television connected to network 103 through a high-speed broadband connection. Mobile telephone 110 may have a small, square screen and may be bandwidth limited with respect to its connection to network 103. Personal computer 103, like television 108, may be connected to network 103 through a high-speed broadband connection, but, unlike television 108, may have a square screen. Each device, e.g., mobile phone 110, television 108, and personal computer 103, may have a different format associated with the device, e.g., a different supported bit-rate, resolution, and/or frame rate. Each device may also support a different compression type and file format, such as Windows Media Video (WMV), Quicktime, Flash Video, MPET-1, MPEG-2, Real Video, MPEG-4/H264, DivX, 3GP, AVI, .DV, .mov, .and asf. Content system 102 may input content in one file format and output content in another file format. Content system 102 may determine format information related to the device for delivering the content (block 706). In one embodiment, although media may be transcoded and/or converted from one format to another, the quality (e.g., resolution) may be kept constant.

Content system 102 may transcode the content (block 708) to match the format requirements of the device for sending the content. Content system 102 may transcode the content after the request for the content, or may transcode the content before the request for the content in anticipation for the request. Transcoding may take place before or after the request for the content depending on the content type and expected demand for the content. In one embodiment, the content and transcoded content may be stored in the same content server 102-1. In one embodiment content server 102-1 may store content regardless of the source of the content (such as mobile phone 110 or video camera 106) or the format of the content. Content system 102 may send the transcoded content to the device (block 708). For example, content may be retrieved from content server 102-1 and delivered through network 103 to customer computer 104, to mobile phone 110, or to television 108.

For example, a parent (e.g., customer 105) may record a child's birthday party using video camera 106. The parent may upload the video through web portal 426 provided by web server 102-2 to content server 102-1. After uploading the video, the parent may request (through web portal 426) that a DVD be manufactured including the video. The parent may specify the postal address of the friend to deliver the DVD. The parent may specify that the manufactured DVD have the label “Birthday Party” attached. The video may be sent from content server 102-1 to MoD facility 116 through network 103. MoD facility 116 may burn a DVD and effect the delivery of the DVD to the friend. The manufactured DVD may include a label “Birthday Party.”

The parent may also indicate that the child's grandmother may be allowed to view the video. The grandmother may view the video on television 108. Before delivering the video to television 108, the video may be transcoded to meet the format of television 108. The grandmother may request that a DVD be manufactured for herself. MoD facility 116 may manufacture another DVD and may effect the delivery of the DVD to the grandmother.

The parent may also indicate that the child's brother be allowed to view the video. The brother may view the video, for example, using mobile phone 110. Before delivering the video to mobile phone 110, the video may be transcoded to meet the format of mobile phone 110.

In another example, a school play may take place at public building 120. Students and teachers may record the play using a video camera like video camera 106. The students may upload the video through web portal 426 provided by web server 102-2 to content server 102-1. The students may upload the play in real-time as it happens. After uploading the video, a parent may request (through web portal 426) that a DVD be manufactured including the video. The parent may specify the postal address of the friend to deliver the DVD. The parent may specify that the manufactured DVD have the label “School Play” attached. The video may be sent from content server 102-1 to MoD facility 116 through network 103. MoD facility 116 may burn a DVD and effect the delivery of the DVD to the friend. The manufactured DVD may include a label “School Play.” Content other than a school play may include a concert or parade.

In one embodiment, the up-link from customer computer 104 to network 103 and servers 102 may be very high, e.g., 25 Mbps over a fiber cable, allowing for a very high-resolution image or video to be received by servers 102 from customer computer 104. Content server 102-2 may store the original media received. Therefore, content server 102-2 may deliver media to MoD facility 116, for example, in the format and quality best suited for manufacturing media, which may be different than the format and quality of same media viewed by customer 105 on computer 104, for example.

In embodiments described herein, a content provider may provide content to content system 102, and the content may be managed, transcoded, and be made available to the various devices. In one embodiment, content system 102 may encrypt content before delivering the content. In another embodiment, content system 102 may alter the content by concatenating content or generating overlays.

MoD facility 116 may allow for the manufacture of physical media including content on a small scale, such as the manufacture of a single DVD. MoD facility 116 may allow for the manufacture of physical media including content on a large scale, such as the manufacture of millions of DVDs.

Embodiments described herein may provide permanent copies of content to authorized destinations, either through a permanent download (with DRM protection) or through the delivery of a copy-protected DVD. Embodiments described herein may provide streaming of content to authorized destinations. Content may be user generated content or professional-grade content.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of acts have been described above with respect to FIGS. 5, 6, and 7, the order of the acts may differ in other implementations consistent with principles of the invention. Moreover, non-dependent acts may be performed in parallel.

It will be apparent that aspects of the embodiments, as described above, may be implemented in many different forms of software, firmware, and hardware in the implementations illustrated in the figures. The actual software code or specialized control hardware used to implement these embodiments is not limiting of the invention. Thus, the operation and behavior of the preferred embodiments were described without reference to the specific software code—it being understood that software and control hardware may be designed to implement the embodiments based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving content in a server from a remote device;
receiving a request to manufacture an optical medium including the content by a manufacturer located remotely from the device;
burning the optical medium including the content by the manufacturer; and
receiving an identity of an intended recipient of the medium for delivering the optical medium.

2. The method of claim 1, wherein receiving content includes receiving content from a user other than the intended recipient.

3. The method of claim 1, wherein receiving content includes receiving content from the intended recipient.

4. The method of claim 1, wherein burning the optical medium comprises burning only a single optical medium.

5. The method of claim 4, wherein burning the optical medium comprises burning a digital versatile disk (DVD), a high-definition DVD, or a blue-ray disk.

6. The method of claim 5, wherein the content includes video, audio, or a game.

7. A system comprising:
one or more servers configured to
receive content from a remote device;
receive a request to manufacture an optical medium including the content;
receive an identity of an intended recipient of the optical medium for delivering the optical medium; and
transmit the content and the identity of the intended recipient to a manufacturer located remotely from the device for burning the optical medium including the content.

8. The system of claim 7, wherein the content received from the remote device is received from a user other than the intended recipient.

9. The system of claim 7, wherein the content is received from the intended recipient.

10. The system of claim 7, wherein the one or more servers is further configured to receive a request for creating only a single optical medium.

11. The system of claim 10, wherein the one or more servers is further configured to forward the request to the manufacturer and the manufacturer burns a digital versatile disk (DVD) including the content in response to the request.

12. The system of claim 11, wherein the content includes video, audio, or a game.

13. A method comprising:
receiving first content in a first format and storing the first content in a server;
receiving a request for the first content from a first user device;
determining format information associated with the first user device;
transcoding the first content for the first user device, wherein transcoding includes changing the first format of the first content based on the format information associated with the first user device;
transmitting the transcoded first content to the first user device.
receiving a request for the first content from a second user device;
determining format information associated with the second user device;
transcoding the first content for the second user device, wherein transcoding includes changing the first format of the first content based on the format information associated with the second user device; and
transmitting the transcoded first content to the second user device.

14. The method of claim 13 further comprising
receiving second content in a second format and storing the second content in the server;
transcoding the second content for the first user device, wherein transcoding includes changing the format of the second content based on the format information associated with the first user device;
transmitting the transcoded second content to the first user device;
transcoding the second content for the second user device, wherein transcoding includes changing the format of the second content based on the format information associated with the second user device; and
transmitting the transcoded second content to the second user device.

15. The method of claim 14, wherein the first content comprises video or audio.

16. A system comprising:
a server configured to
receive first content having a first format and storing the first content;
receive a request for the first content from a first user device;
determine format information associated with the first user device;
transcode the first content for the first user device, wherein transcoding includes changing the first format of the first content based on the format information associated with the first user device;
transmit the transcoded first content to the first user device.
receive a request for the first content from a second user device;
determine format information associated with the second user device;
transcode the first content for the second user device, wherein transcoding includes changing the first format of the first content based on the format information associated with the second user device; and
transmit the transcoded first content to the second user device.

17. The system of claim 16, wherein the server is further configured to
receive second content having a second format and storing the second content in the server;
transcodes the second content for the first user device, wherein transcoding includes changing the second format of the second content based on the format information associated with the first user device;
transmit the transcoded second content to the first user device;
transcode the second content for the second user device, wherein transcoding includes changing the second format of the second content based on the format information associated with the second user device; and
transmit the transcoded second content to the second user device.

18. The system of claim 17, wherein the first content and second content include video or audio.

19. The system of claim 18, wherein the first user device is a mobile phone and the second user device is a television or wherein the first device is a television and the second user device is a computer.

20. The system of claim 17, wherein the first content is high format video and the second content is lower format content.
